(19) United States
(12) Patent Application Publication
(10) Pub. No.: US 2009/0243391 A1
(43) Pub. Date: Oct. 1, 2009

(54) MULTI-FUNCTIONAL POWER SUPPLY WITH POWER OVER ETHERNET SUPPORT, INTEGRATED MONITORING AND SUPPLEMENTAL POWER SOURCE BACKUP

(76) Inventors: Walter Susong, III, Alpharetta, GA (US); Jim Johnson, Winder, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/060,233

(22) Filed: Mar. 31, 2008

(51) Int. Cl. H02J 1/00; H02J 7/00

(52) U.S. Cl. 307/66; 320/137

(57) ABSTRACT

A multi-functional power supply that is advantageously suitable for distributed networking environments, such as the deployment of wireless networks. The power supply provides PoE ports for powering various devices and includes redundancy, back-up support, failover detection and monitoring/reporting. Thus, the power supply is particular well suited for a router or switch type environment that enables powered devices to be located in strategic locations without being limited by the provision of AC power outlets.

### CROSS-REFERENCE TO RELATED DOCUMENTS

The standards developed by the Institute for Electrical and Electronics Engineers having a title of IEEE 802.3af and created in June of 2003, as well as the proposed standard IEEE802.3at, and any modifications thereto are hereby incorporated by reference.

### BACKGROUND

You don't see them on the front page of TIME MAGAZINE, and you don't see them standing next to Steve Jobs or Bill Gates during the big roll-out announcements at the huge technology shows but, there in back of the lab scrawling on paper and scratching their heads are the engineers that make it all happen. A non-glamorous aspect of today's electronic age is the provision of power. However, the engineering marvels in the creation of new and novel methods for providing power have been a key factor in the size reduction and the sleek profile of today's portable electronics. Meeting the size, weight and portability requirements imposed by the market can be contributed to the ability of power supply designers to generate compact, light-weight and highly efficient power supplies. Without these engineers, our current note-book computers would still resemble those “luggable” computers that were first introduced to the market as being portable. And before cellular telephones fit nicely in your shirt pocket, we had to carry them around in lunchbox sized bags.

Power supply designers have introduced a wide variety of technologies such as extended life batteries, quick charge cycles for batteries, uninterruptible power supplies, and cleverly grabbing power from other sources to help for fully power a load. With regards to this last innovation, a recent development in the industry has been the provision of power by delivering it over a local area network, or Ethernet. This technology has been coined as Power-over-Ethernet or PoE.

Prior to the introduction of PoE, network designers would work within the confines of locating access points based on the availability of AC (alternating current) electrical outlets. Network design activity was significantly constrained by either having to locate an access point within a 5-6 foot range of an AC outlet or, identifying locations at which the installation of a new AC power outlet would not be too difficult. Succinctly stated, PoE operates by placing power onto an Ethernet cable at the source, and a powered device extracts that power at the destination. Thus, the destination device is completely powered over the Ethernet cable and no extension cords or AC outlets are required.

More specifically, in the provision of power by means of PoE technology, only one Ethernet cable is required to run to the access point or Ethernet device for supplying both power and data. With PoE, power-sourcing equipment detect the presence of an appropriate “powered device” (e.g., an access point or Ethernet hub) and injects applicable current into the data cable. An access point can operate solely from the power it receives through the data cable.

Several advantages are available from the use of PoE technology. Such advantages include: (a) reducing installation cost by reducing the need for the installation of conduit, electrical wiring, and outlets throughout a location; (b) providing more flexibility in network design by enabling access points, hubs, etc. to be placed at the most strategic locations rather than the most AC power convenient location (for instance in an environmental setting such as outside, no AC outlet may be available); (c) higher reliability and control by centralizing the location of the power source and creating the ability to selectively provide or remove power from remote network devices; (d) less cost for internationally sold products in that the power connections are the same regardless of the power standards in the various countries.

There are multiple manners in which PoE can be provided. For instance, PoE may be provided using the spare wires in the typical Ethernet cable. The Unshielded Twisted Pair wiring (UTP) for Ethernet cables includes 8 wires which are twisted into 4 pairs of lines. Only two pairs of the twisted lines are utilized by the Ethernet standard for the delivery of data. Thus, the other two twisted pairs are available. These extra twisted pairs are often used for the provision of PoE. However, as is the case with the introduction of most new technologies, many designers have many ideas and implementations, some of which can create compatibility issues. For instance, in some networks one ore more of the spare twisted pairs may already be utilized, such as by connecting to ordinary analog telephones.

Another way to provide PoE is by utilizing the data wires. The original standard for PoE that was introduced by the Institute for Electrical and Electronics Engineers (IEEE) in June of 2003 (the IEEE 802.3af standard) provides for the provision of PoE by using the same twisted pairs that the Ethernet protocol used for the delivery of data. Thus, the spare pairs remain free for other uses. This method operates by adding DC power to the data pairs using signal transformers. At the destination, the DC power is pulled off the line in a similar fashion.

A third method for providing PoE is a combination of the first two methods. The new version of the IEEE 802.3af standard allows the spare wire pairs to be energized and/or the power to be provided over the data wires.

The IEEE 802.3af standard divides the provision of PoE into two classes: Power Sourcing Equipment (PSE) such as hubs and routers, and powered devices such as IP phones and wireless access points. Powered devices are classified by the amount of power they consume. Ethernet ports on PSE may supply a nominal voltage of 48 V DC power on the data wire pairs or on the spare wire pairs, but not both. In general, a PSE does not send power to a device that does not expect it. The provision of PoE is managed by a multi-stage handshaking protocol to protect equipment from being damaged and to manage power budgets.

PoE technology generally resides in mid-span equipment (“power hubs”) that reside between the Ethernet switch of the wired side of the network and the access points. Many access point vendors sell power hubs that are rack mountable to combine the AC power and network data onto the same Cat 5 unshielded twisted pair cabling that runs from the switch to each access point. Power hubs often have multiple ports to operate up to 12 access points.

In some cases, Ethernet switch vendors implement PoE within each switch port (referred to as “end-span”), which avoids the need for separate power hubs. With this configuration, you can plug the data cable from PoE-enabled access points directly into the Ethernet switch. This is the optimum solution, but most companies installing wireless LANs today already have existing switches that don't implement PoE. As a result, the use of power hubs is the most common solution

The IEEE 802.3af describes the workings of PoE as follows. Initially a signature process is performed in which a PSE probes a device to see if it is IEEE 802.3af compliant. The probing is performed by applying two current limited voltages between 2.7 V and 10 V, and looking for a signature impedance of 25 k ohms. The device is allowed two diode voltage drops in series with the signature impedance and so, two current limited voltage points above the diode drops must be used. Non-PoE devices will usually have impedance that is below 1 k ohm or will appear as an open circuit with many mega-ohms of resistance. If the signature impedance of an IEEE 802.3af device is not seen, then PoE is not provided to that device.

However, if the signature impedance is detected, the PSE then attempts to classify the device. The classifying process includes providing a classification voltage between 15 V and 20 V to the device. The device is classified by drawing a specific current to identify itself in a power class.

If a powered device is disconnected from the cable over which PoE is being provided, the PSE detects this change in state and then removes the provision of power over that cable. Thus, if a device is reconnected, the signature and classification procedures must be repeated again prior to the provision of PoE.

Another aspect of power supply engineering that is of significant importance in the networking and computer industry is the design and inclusion of uninterruptible power supplies (UPS). In general, a UPS is designed so that there is one source of power that is normally used (the primary source), and another source that comes on-line if the primary source is disrupted. This is referred to as the backup power or secondary source. For instance, in a typical configuration, the primary power source is obtained from an AC outlet while the secondary power source is provided from a battery or generator. A switch is used to control which of these sources powers the equipment at any given time. Typically, the switch automatically changes from the primary source to the secondary when it detects that the primary power has been removed or interrupted. It switches back from the secondary power source to the primary when it detects that the primary power source is once again available.

In designing communication systems, networks, data networks, etc., a significant amount of effort is expended in designing the provision of power within the system. In a highly distributed system, the power design can be complicated and expensive. Furthermore, in communication system that seeks to gain the most coverage with the minimum amount of equipment, much flexibility in the placement of nodes is required. For instance, in a wireless network, especially one in which the terrain includes buildings and foliage, placement of transmitters, receivers and access points must remain flexible. In addition, for such a wireless network, the space on the antenna towers is at a premium and is generally controlled by the amount of weight that is installed on the antenna tower. Having to include a power supply or even an AC to DC converter in the tower mounted equipment can greatly increase the cost of deployment.

What is needed in the art is a power supply unit, device or system that can provide PoE functionality to devices, such as tower mounted devices, as well as UPS support, but that can be mounted off of an antenna tower. Furthermore, because each piece of equipment in a network design can easily propagate significant costs in the network deployment, what is needed is a power supply system that not only meets the PoE and UPS requirements, but that can also serve as a replacement for other equipment. The various features, aspects and embodiments of the present invention as described in this specification address these and other needs in the art.

### BRIEF SUMMARY

The present invention is directed towards a universal power supply that is ideally suitable in a distributed network design with limited access to power sources. The various embodiments of the present invention include varying sets of features aspects and capabilities. One embodiment of the present is a power supply that includes a secondary power supply based on a chargeable battery and an AC input interface for receiving an AC signal. The power supply includes a power supply module that monitors the AC input interface to determine if the AC signal is interrupted. The power supply module converts the AC signal into a DC signal for powering devices over a PoE port. In addition, the power supply module can test the secondary power supply source to verify that it is functional to handle the load. For instance, a load can be applied to the secondary power source and its ability to source the necessary current can be determined. If the AC signal is interrupted the power supply module enables the secondary power source to provide power to the PoE ports in lieu of the AC based signal. Thus, the power supply module can include the ability to determine power requirements for a given load and then apply a comparable load to the secondary power source for testing.

The present invention can be embodied in a power supply, a power module incorporated into other equipment or as a power supply system including other functionalities. For instance, another embodiment of the present invention includes a power supply system that can be incorporated into a network based device and used to power one or more PoE ports. Such an embodiment can include a chargeable battery, a plurality of PoE ports and an alternating current input interface for receiving an alternating current signal. Furthermore, the power supply system includes a power supply module that can monitor the alternating current input interface to convert a received alternating current signal into a direct current signal. The direct current signal can then be applied to at least one PoE port. The power supply module is further able to test the chargeable battery to ensure that it can handle a load, identify an interruption in an alternating current signal and control whether the PoE port is driven by the DC signal or the chargeable battery. Furthermore, this embodiment includes a failover communication interface enabling the power supply to be communicatively coupled with at least one backup power supply operating in an off-line mode and a failover module. The failover module detects a failure in the power supply unit and takes steps to switch over to a backup power supply. Such actions include requesting a backup power supply to change to an on-line mode for providing power to devices current attached to the PoE ports of the power supply system and switching the power supply unit to an off-line mode after receiving a response from the backup power supply indicating that the backup power supply can change to an on-line mode. The power supply also includes a monitor module that enables the power supply unit to be monitored and controlled over an interface to an external device.

These embodiments, as well as other embodiments, aspects and features of the present invention are more fully described in the description that follows along with the figures.

### BRIEF DESCRIPTION OF THE SEVERAL VIEWS OF THE DRAWING

FIG. 1 is a functional block diagram illustrating various components of functions incorporated into an exemplary embodiment of the present invention.

FIG. 2 is a conceptual diagram of one embodiment of the failover aspect of the present invention.

FIG. 3 illustrates yet another embodiment of the failover aspect of the present invention.

FIGS. 4A and 4B are flow diagrams illustrating one embodiment of the failover operation aspect of the present invention. FIG. 4A illustrates the steps involved with the active unit while FIG. 4B illustrates the steps involved with a potential take-over unit.

### DETAILED DESCRIPTION OF EMBODIMENTS OF THE INVENTION

The present invention, as well as features and aspects thereof, is directed towards providing a versatile power supply for powering devices with PoE. In general, the power supply will accept any alternating current (AC) input and convert it to the necessary direct current (DC) output voltage necessary to power devices over a PoE interface. One aspect of an embodiment of the invention is the provision of power or line conditioning. Another aspect of an embodiment of the invention is the provision of a backup power source when the primary power source fails. Other aspects and features of various embodiments of the invention include: the provision of combined PoE and data ports; pass through data ports; operation with one or more partners for failover support; optically isolated communications between failover partners; and management, control and reporting over TCP/IP interfaces.

Turning now to the figures, these embodiments, aspects and features of the present invention, as well as others are described in more detail.

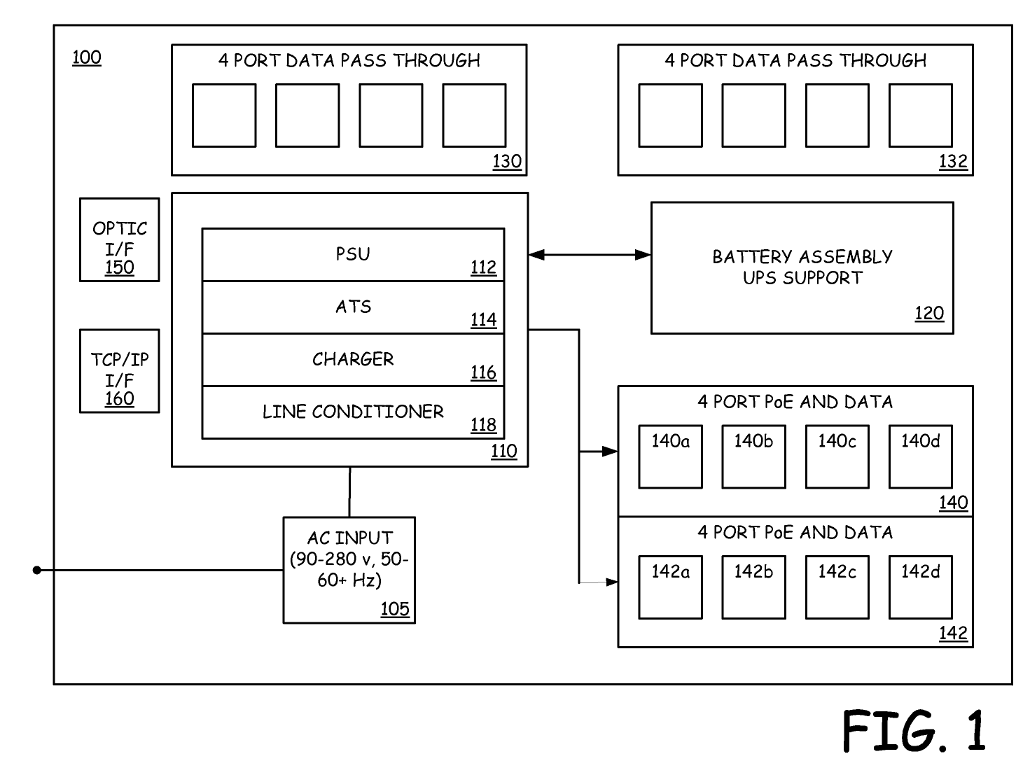

FIG. 1 is a functional block diagram illustrating various components of functions incorporated into an exemplary embodiment of the present invention. The illustrated embodiment includes an AC power interface 105 to accept an AC input power signal from an AC source. The AC power interface 105 may include a variety of characteristics, such as noise filtering, surge protection, or the like. In addition, the AC input may accept a wide range of AC input signals, such as voltage levels ranging from 90 volts to 280 volts and frequencies ranging from 50 hertz to 60 or more hertz. Thus, such an embodiment can operate worldwide regardless of the power source. The received AC input is then provided to the power supply module 110.

The power supply module (PSU) 110 illustrated includes a power supply unit 112, an auto transfer switch (ATS) 114, a charger 116 and a line conditioner 118.

The embodiment illustrated in FIG. 1 further comprise a battery assembly 120, one or more sets of data pass through ports 130 and 132 and one or more sets of combined PoE and data ports 140 and 142, an optical port 150 for communication with external devices (including additional power supplies) and a TCP/IP communication port or interface 160 for management and control of the power supply 100 and reporting by the power supply 100. It should be appreciated that these components may be physical or functional in nature and thus, the separation illustrated is not limiting on the actual embodiment of the invention. In addition, some embodiments of the power supply may include fewer than the illustrated components while others may include additional components. The present embodiment is being presented as a non-limiting example to provide an overall understanding of the operation of various embodiments of the present invention.

The input AC signal is first provided to a line conditioner 118. The line conditioner can operate to remove spikes and noise that may be riding on the input AC signal. Thus, noise filters can be utilized to clean up the input AC signal. The conditioned input AC signal is then converted to a DC signal by the PSU 112. Depending on the various embodiments, the PSU 112 may employ a variety of techniques for converting the AC signal into a DC signal and those skilled in the art will be familiar with such techniques.

The PSU 112 is the heart or intelligence of the power supply 100, or at least the resident intelligence as in some embodiments, additional functionality can be controlled external to the power supply 100. The PSU 112 may include a variety of functionalities and configurations. For instance, in one embodiment of the invention, the PSU 112 may incorporate programmable logic. As such, the PSU 112 can be programmed to control the power supply 100, collect data for status and trending, control the other components of the power supply, provide specialized reporting, etc. In addition, the PSU 112 can incorporate commercially available components such as the MAX5941A/MAX5941B chipset available from MAXIM, the TPS237x available from TEXAS INSTRUMENTS, the HV110 available from SUPERTEX as well as others to provide PoE functionality. The PSU 112 can also include a microcontroller, a microprocessor with memory, or some other equivalent to a central processor that enables further control to be obtained by creating and loading software instructions into the device to perform various tasks.

The power supply module 100 interfaces to the battery assembly 120 through a charger 116. The functionality of the charger 116 may vary from embodiment to embodiment but in general can include the ability to monitor a current charge on the battery, test the battery under load, and charge the battery in a fast and/or trickle charging mode as well as maintain a charge on the battery(ies). In an exemplary embodiment, lithium-ion polymer (or lithium polymer or LIPO) batteries are utilized. Advantageously, the lithium polymer batteries are small but have a high capacity. In the typical setting for the present invention, the goal of the batteries is not to provide extended alternate power source, although some embodiments may be configured to do so. However, the typical embodiment aims to provide, at a minimum, sufficient power source to allow for an orderly shutdown of the system in the event of a loss of primary power. Because lithium polymer batteries do not require metal battery cell casing, the battery pack can be lighter and it can be specifically shaped to fit the device it will power. Because of the denser packaging without intercell spacing between cylindrical cells and the lack of metal casing, the energy density of Li-poly batteries can be over 20% higher than that of a classical Li-ion battery and store more energy than nickel-cadmium (NiCd) and nickel metal hydride (NiMH) batteries of the same volume. Thus, the lithium polymer batteries are well suited for such an embodiment and in such an embodiment, the charger 116 would employ intelligence to properly charge and maintain the lithium polymer batteries.

The power supply module 110 also includes the auto transfer switch (ATS) 114. The ATS 114 includes intelligence to perform a swap in the power source of the power supply 100 in the event that the AC power source fails. Thus, if AC power is removed for a threshold period of time, drops below a threshold level or otherwise becomes unstable, the ATS 114 can throw a switch to enable further powering of the devices supplied by this power supply 100 to be provided from the battery assembly 120 rather than the AC input 105.

The power supply 100 includes two sets of combined PoE and data ports 140 and 142. In the illustrated embodiment either method of providing the PoE can be employed. Typically, Ethernet ports are provided in groups of 4 and as such, each of the sets of combined PoE and data ports 140 and 142 are shown as including 4 ports (140a-d and 142a-d). However, it will be appreciated that the power supply 100 can include any number of sets of ports and each set may include any number of ports. In addition, a single set of ports may be provided with only PoE and data ports or a combination of some PoE and data ports with data only ports. The power provided to the PoE and data ports comes from the power supply module 110 and is in conformance with the IEEE 802.3af standards or other applicable standards.

The power supply 100 may also include one or more sets of data only or data pass-through ports. In the illustrated embodiment, two sets of 4 port data pass-through ports are illustrated 130 and 132. Thus, in the illustrated configuration, the power supply 100 is actually a router that incorporates the power supply. It should be appreciated that the inclusion of the ports can be optional and thus, some embodiments of the invention may simply include the power supply specific components and thus, the present invention should not be limited to only embodiments that include ports. In other embodiments, the power supply aspects of the inventions can be incorporated into a variety of settings, devices, and applications including as non-limiting examples, routers, wireless routers, hubs, switches, PBX systems, wireless access points, etc.

Another aspect of the present invention that can be incorporated into various embodiments is the failover functionality. In general, as previously described, the operation and capacity of the battery assembly 120 can be periodically tested to verify that it is functioning properly. If the operation of the battery assembly is not within a desired standard, or if it is simply necessary or desired to take a power supply unit off-line, an alternate power supply unit can be employed.

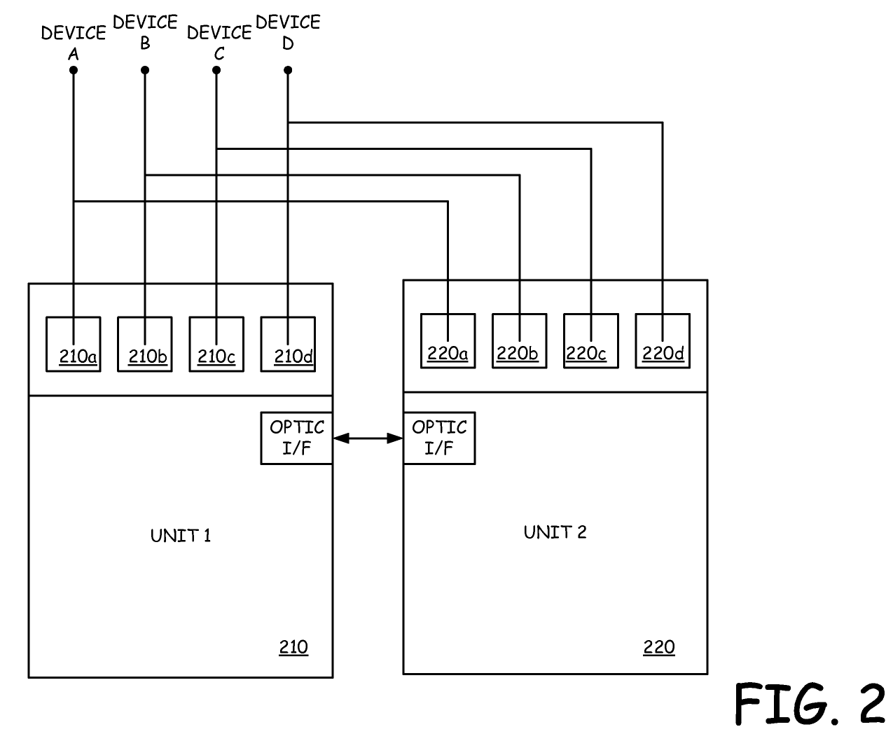

FIG. 2 is a conceptual diagram of one embodiment of the failover aspect of the present invention. Two units 210 and 220 are illustrated, although it will be appreciated that more units may also be employed. For purposes of illustration, Unit 1 210 is assumed to be on-line and driving ports 210a-d for support DEVICES A-D respectively and Unit 2 is off-line. In this embodiment, Unit 2 220, having ports 220a-d would include a means for isolating the ports 220a-d from the cables extending from 210a-d to DEVICES A-D. Thus, when Unit 1 is active, the PoE ports 210a-d are driven by Unit 1 210. If it is determined that Unit 2 is to take over, the two units can communicate with each other over the optic interfaces and decide to make the switch. When the switch occurs, the ports 210a-d become isolated while the ports 220a-d become active for driving the DEVICES A-D. It will be appreciated that this aspect of the invention can be employed in different manners.

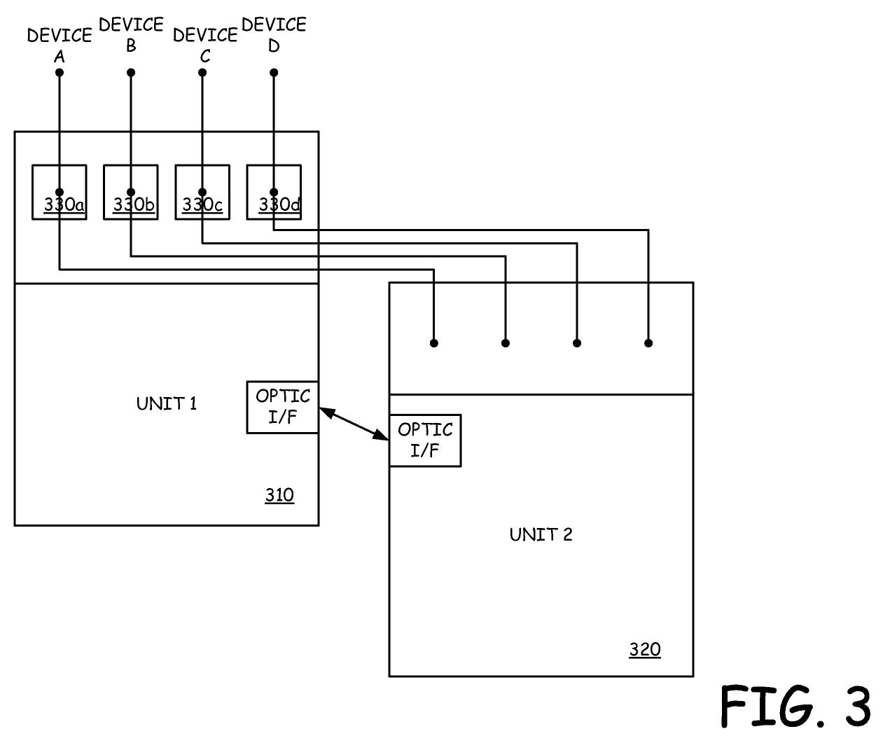

FIG. 3 illustrates yet another embodiment of the failover aspect of the present invention. In the illustrated embodiment, Unit 1 310 and Unit 2 320 share a set of ports 330a-d. In this embodiment, simply the power supplied to the ports is changed rather than having to include the necessary hardware or components for isolating the other ports.

A specific advantageous aspect of various embodiments of the present invention is the ability to test the battery assembly 120 under a loaded condition. For instance, the load required on the battery can be easily ascertained by monitoring the load on the current power supply. This ascertained load, or simply some other load can be switched on to the battery assembly 120 to test the functionality of the battery assembly and its ability to handle the load.

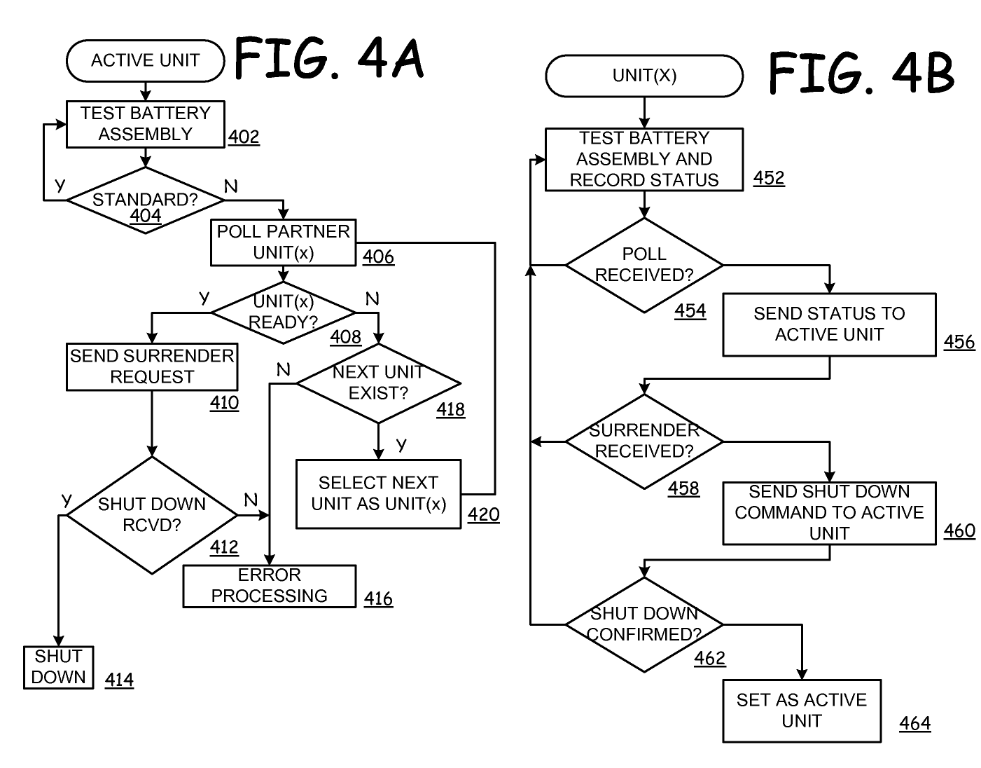

FIGS. 4A and 4B are flow diagrams illustrating one embodiment of the failover operation aspect of the present invention. FIG. 4A illustrates the steps involved with the active unit while FIG. 4B illustrates the steps involved with a potential take-over unit. Initially the active unit conducts a test of the battery assembly. The failover function of the present invention may be provided in software, firmware, hardware or a combination of two or more of these. In addition, the failover operation may be fully embedded in the system 100, fully external to the system 100 or distributed between the system 100 and external devices. The failover mechanism may include the secondary power supply or batter load testing function 402, as well as other tests, and maintaining a status of the battery assembly. The status of the battery can be compared to a standard status value 404. If the status of the battery assembly is within a threshold value or within the desired or required tolerances, then the battery assembly may be considered as operating in accordance with accepted standards and processing continues at step 402.

If the battery assembly is not operating in accordance with the required standard, then a partner unit (if one exists) is polled 406.

The partner units, similar to the active unit, periodically test the status of its respective battery assemblies and records the status 452. In other embodiments, it may simply test the battery assembly on the fly as needed rather than storing the status. If the partner unit receives a poll (step 406 of FIG. 4A) the unit responds by sending the current status to the polling or active device 456. Otherwise, the partner simply continues to test and monitor the battery assembly.

If the active unit receives a ready status from the polled partner unit 408, the active unit sends a surrender request to the ready unit 410. The surrender request basically informs the partner unit that the active unit needs to relinquish control and pass control to the partner.

If the partner unit receives a surrender 458, the partner unit then sends a shut down command to the active unit 460. This command indicates that the partner unit is ready and able to become the active unit and is instructing the current active unit to shut down. However, if a shut down command is not received 458, then the partner unit can (a) delay indefinitely until one is received, (b) time-out and revert to step 452 to test the assembly (as shown) or (c) in other embodiments may enter error processing and recovery.

If the active unit receives the shut down command 412, the active unit performs a shut down sequence and sends a confirmation command 414 to the partner unit that shut down is complete. This confirmation completes the handoff of the active status. However, if the active unit does not receive the shut down command 412, then the active unit enters error processing 416. In error processing, the active unit may send an alert to an administrator, sound an alarm, etc.

When the partner unit receives the confirmation of the shut down from the active unit 462, the partner unit then becomes the active unit and processing continues for the new active unit at step 402. The process of becoming the active unit includes performing all the actions necessary to ensure that power to the PoE ports, or to devices connected to the PoE ports is now provided by the new active unit. In addition, the process of shutting down the previously active unit includes switching out and isolating the ports of the current active unit from the devices being driven by the PoE.

Referring back to step 408, if the partner unit does not provide a ready status, then the active unit can check to see if any additional partner units exist or are available 418. If no other partners are available, the active unit may enter error processing 416. However, if another partner unit is available, the next partner unit is selected as the unit(x) and processing continues with step 406.

Referring back to FIG. 1, the power supply is also shown as including an optically isolated interface 150 and a TCP/IP interface 160. In an exemplary embodiment, the optic interface 150 is used for communication between multiple systems 100. Thus, for the above-described communications associated with FIG. 4, the optic interface 150 is used to carry the data, handshaking, etc. However, it will be appreciated that multiple systems 100 could also be interconnected through the data ports, RF transmissions or other wireless communications methods, the TCP/IP interface 160 or by using other means.

The TCP/IP interface 160 provides access for controlling and monitoring the system 100, as well as receiving status information from the system 1 00. For instance, an external device can interact with the system 100 through the TCP/IP interface. In various embodiments, the intelligence for controlling the system 100 can be located on different platforms. For instance, in one embodiment, the power supply module 110 may include a processor and software/firmware/hardware to provide a monitor program that can be exercised through the TCP/IP interface 160. Thus, a dummy terminal having a TCP/IP interface could interact with the monitor program to control, monitor and obtain status for the system 100. In another embodiment, the power supply module 110 may include the intelligence to drive a browser window through the TCP/IP interface 160. Thus, the system 100 could be assigned an Ethernet address and/or a TCP/IP address and by entering the appropriate address into a browser, such a INTERNET EXPLORER, NETSCAPE, MOZILLA, etc. the available functions can be displayed within the browser window. From here an administrator could login to the system 100 and if successfully logged in, can control and monitor the system 100. Advantageously, this would allow an administrator to access and control the power supply from any location. In other embodiments, the intelligence may reside in an external program that can send commands to the system 100. The power supply module 110 can receive the commands, interpret the command and then respond accordingly. Alternatively, certain status and control functions can be actuated by providing access to specific memory locations through the TCP/IP interface 160 and thus, all intelligence would reside in an external device. In yet another embodiment, the power supply may be equipped with a wireless telephone communication or cellular capability and thus, control of the device can be attained through a telephone call using IVR and touch tone signals, SMS and text messaging, or the like. It will be appreciated that a blend of intelligence distribution can also be employed in various degrees. In addition, rather than putting the intelligence into the power supply module 110, a separate control and monitoring module may be added to the system 100.

Typical types of controls and monitoring functions that can be employed over the TCP/IP interface 160 include disabling the system 100, forcing a switch between active systems, requesting a battery test and obtaining status, verifying the operation of various components within the system 100, notifying the system 100 that a new battery has been installed, obtaining data regarding the charging life cycles of the battery, identify the current load on the system, test the data ports, identify the usage of the data ports, identify the data through put through the system, modify the configuration of the system 100, disable and/or enable certain data ports, force a PoE verification for a port, as well as other functions. In addition, certain reports can be defined externally and requested of the system 100 or the system 100 can periodically provide previously defined reports pertaining to the operation of the system 100 to a device connected to the TCP/IP interface 160.

It will also be appreciated that one or more of the data ports 130a-d, 132a-d, 140a-d, and 142a-d can be used to control and monitor the system 100 rather than the TCP/IP interface 160. In addition, status and reports pertaining to the system 100 can be sent out via email rather than by requesting them to be downloaded. For instance, the power supply unit 110 can access an email server over the TCP/IP interface 160 and send an email to a programmed email address.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In this application the words “unit” and “module” are used interchangeably. Anything designated as a unit or module may be a stand-alone unit or a specialized module. A unit or a module may be modular or have modular aspects allowing it to be easily removed and replaced with another similar unit or module. Each unit or module may be any one of, or any combination of, software, hardware, and/or firmware.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A power supply comprising:
a chargeable battery based secondary power supply;
an alternating current input interface for receiving an alternating current signal;
a power supply module that is operative to:
convert the alternating current signal into a direct current signal;
provide the converted direct current power to at least one power over Ethernet port;
monitor the alternating current input interface to identify an interruption in an alternating current signal;
test the chargeable battery based secondary power supply to ensure that it is operating correctly; and
switch the power provided to the at least one power over Ethernet port from the converted direct current power signal to the chargeable battery based secondary power supply.

2. The power supply of claim 1, wherein the power supply module further comprises a charger that is operative to charge the chargeable battery based secondary power supply.

3. The power supply of claim 1, wherein the power supply operating in an on-line mode provides power to a load and further comprising:
a failover communication interface enabling the power supply to be communicatively coupled with at least one backup power supply operating in an off-line mode; and
a failover module operative to:
detect a failure in the power supply;
request a backup power supply to change to an on-line mode to provide power to the load; and
switching the power supply to an off-line mode.

4. The power supply of claim 3, further comprising a plurality of power over Ethernet based ports.

5. The power supply of claim 4, wherein the power supply is incorporated into a router.

6. The power supply of claim 5, further comprising a monitor module operative to:
monitor the status of the power supply; and
provide status information to an external device.

7. The power supply of claim 6, wherein the monitor is further operative to:
receive a command from the external device; and
modify the operation of the power supply in accordance with the received command.

8. The power supply of claim 7, wherein the monitor is further operative to drive a browser.

9. The power supply of claim 7, further comprising a TCP/IP interface over which an external device can interact with the monitor.

10. The power supply of claim 9, further comprising a line conditioner this is operative to receive alternating current signals over an approximate range of 90 volts to 280 volts.

11. The power supply of claim 10, wherein the line condition is further operative to receive alternating current signals over an approximate range of 50 hertz to 60 hertz.

12. The power supply of claim 6, further comprising a plurality of Ethernet ports.

13. The power supply of claim 3, wherein the failover communication interface is optical.

14. The power supply of claim 1, wherein the chargeable battery based secondary power supply includes one or more lithium-ion polymer battery cells.

15. A power supply unit that can be incorporated into a network based device and used to power one or more PoE ports, the power supply module comprising:
an alternate power source interface;
an alternating current input interface for receiving an alternating current signal;
a power supply module operative to:
monitor the alternating current input interface to identify an interruption in an alternating current signal;
convert the alternating current signal into a direct current signal;
provide the converted direct current power to at least one PoE port;
test the alternate power source to ensure that it can handle a load; and
switch the power provided to the one or more PoE ports from the converted direct current power signal to the alternate power source.

16. The power supply unit of claim 15, wherein the power supply unit provides power to a load and further comprising:
a failover communication interface enabling the power supply to be communicatively coupled with at least one backup power supply operating in an off-line mode; and
a failover module operative to:
detect a failure in the power supply unit;
request a backup power supply to change to an on-line mode to provide power to the load; and
switching the power supply unit to an off-line mode.

17. The power supply unit of claim 16, wherein the power supply module is operative to:
switch the power provided to the one or more PoE ports from the converted direct current power signal to the alternate power source if the power supply module detects an interruption in the alternating current signal.

18. The power supply unit of claim 17, wherein the failover module is further operative to:
switch the power supply unit to an off-line mode only after receiving a response from the backup power supply indicating that the backup power supply can change to an on-line mode.

19. The power supply unit of claim 18, wherein the alternate power source is one or more lithium-ion polymer cells and the power supply module is further operative to charge the alternate power source and further comprising a monitor module that enables the power supply unit to be monitored and controlled over an interface to an external device.

20. A power supply system that can be incorporated into a network based device and used to power one or more PoE ports, the power supply system comprising:
a chargeable battery;
a plurality of PoE ports;
an alternating current input interface for receiving an alternating current signal;
a power supply module operative to:
monitor the alternating current input interface to identify an interruption in an alternating current signal;
convert the alternating current signal into a direct current signal;
provide the converted direct current power to at least one PoE port;
test the chargeable battery to ensure that it can handle a load;
switch the power provided to the one or more PoE ports from the converted direct current power signal to the chargeable battery if a disruption in the alternating current signal is detected;
a failover communication interface enabling the power supply to be communicatively coupled with at least one backup power supply operating in an off-line mode; and
a failover module operative to:
detect a failure in the power supply unit;
request a backup power supply to change to an on-line mode for providing power to devices current attached to the PoE ports of the power supply system; and
switching the power supply unit to an off-line mode after receiving a response from the backup power supply indicating that the backup power supply can change to an on-line mode; and
a monitor module that enables the power supply unit to be monitored and controlled over an interface to an external device.
